(19) United States
(12) Patent Application Publication
(10) Pub. No.: US 2019/0160634 A1
(43) Pub. Date: May 30, 2019

(54) PLIERS

(71) Applicant: JIN FU CHEN, TAICHUNG CITY (TW)

(72) Inventor: JIN FU CHEN, TAICHUNG CITY (TW)

(21) Appl. No.: 15/827,150

(22) Filed: Nov. 30, 2017

(51) Int. Cl. B25B 7/14; B25B 7/02

(52) U.S. Cl. CPC B25B 7/14; B25B 7/02

(57) ABSTRACT

A pliers includes a first body including an engaging groove, a second body, and a tap-button mechanism. The second body is pivoted with the first body, and the first body is pivotable relative to the second body. The tap-button mechanism includes two positioning grooves at the second body and a tap button pivoted on the second body. When the first body comes close to the second body, the tap button can be tapped to a first position and engaged in the engaging groove. Thus, the first body is blocked and cannot pivot relative to the second body. The tap button can be tapped to a second position and detached from the engaging groove. Thus, the first body is pivotable relative to the second body. A positioning block is extending from the tap button and can be engaged in any of the positioning grooves for positioning the tap button.

### BACKGROUND OF THE INVENTION

### Field of the Invention

The present invention relates to a pliers, in particular to a tap button structure of the pliers.

### Description of the Prior Art

As shown in FIG. 9, a conventional pliers is illustrated. On one of the pliers bodies 41, a tap button 5 is assembled with a shaft 51. When the two pliers bodies 41, 42 are in a closed state, the tap button 5 can be tapped inwardly to abut against the pliers body 42. Therefore, the two pliers bodies 41, 42 are positioned with each other and cannot be pivoted relative to each other. Hence, when the conventional pliers is not in use, the pliers can be kept in the closed state to prevent from hurting the user unintentionally. When the user tends to use the pliers, the tap button 5 can be tapped outwardly, so that the two pliers bodies 41, 42 can be pivoted relative to each other, and then the user can use the pliers.

However, although the tap button 5 can be used to position the two pliers bodies 41, 42 with each other, the tap button 5 is devoid of a positioning mechanism. In other words, the tap button 5 is freely pivotable relative to the pliers body 41. Even if the tap button 5 is tapped inwardly and the two pliers bodies 41, 42 are positioned with each other, a foreign force may be applied on the tap button 5 to make the tap button 5 have unexpected rotation and detach from the pliers body 42. As a result, the pliers bodies 41, 42 of the conventional pliers are not firmly pivoted with each other when the conventional pliers is in the closed state, and the pliers may still be opened to hurt the user in an unintentional manner.

### SUMMARY OF THE INVENTION

One object of the present invention is to provide a pliers having a structure for positioning the tap button to prevent the unwanted movements of the pliers bodies from each other and the change of the opened/closed state of the pliers.

In view of these, a pliers is provided. In one embodiment, the pliers comprise a first pliers body, a second pliers body, and a tap-button mechanism. The first pliers body comprises an engaging groove. The second pliers body is pivoted with the first pliers body, so that the first pliers body is pivotable relative to the second pliers body to come close to or goes away from the second pliers body. The tap-button mechanism comprises two positioning grooves and a tap button. The two positioning grooves are at the second pliers body. The tap button is pivoted on the second pliers body. When the first pliers body comes close to the second pliers body, the tap button is capable of being tapped to a first position and engaged in the engaging groove, so that the first pliers body is blocked by the tap button in the engaging groove and cannot pivot relative to the second pliers body. The tap button is also capable of being tapped to a second position and detached from the engaging groove, so that the first pliers body is pivotable relative to the second pliers body. A positioning block is extending from the tap button, and the positioning block can be engaged in any of the positioning grooves according to a position of the tap button for positioning the tap button.

In one embodiment, the second pliers body comprises an elongated slot, and the two positioning grooves are in the elongated slot. A protruding portion is protruding from the elongated slot and between the two positioning grooves. An outline of the elongated slot is curved to correspond to a trace of the tap button.

In one embodiment, the tap-button mechanism further comprises a housing covering the tap button. The tap button is pivoted on the second pliers body by a shaft, and the housing comprises a receiving groove corresponding to the shaft.

### BRIEF DESCRIPTION OF THE DRAWINGS

FIG. 1 illustrates a perspective view of a pliers according to a first embodiment of the present invention;

FIG. 2 illustrates a plan view of the pliers of the first embodiment;

FIG. 3 illustrates an exploded view of the pliers of the first embodiment;

FIGS. 4 to 6 illustrate sectional views showing operations of the pliers of the first embodiment;

FIG. 7 illustrates an exploded view of a pliers according to a second embodiment of the present invention;

FIG. 8 illustrates a plan view of a pliers according to a third embodiment of the present invention; and

FIG. 9 illustrates an exploded view of a conventional pliers.

### DETAIL DESCRIPTION OF THE PREFERRED EMBODIMENTS

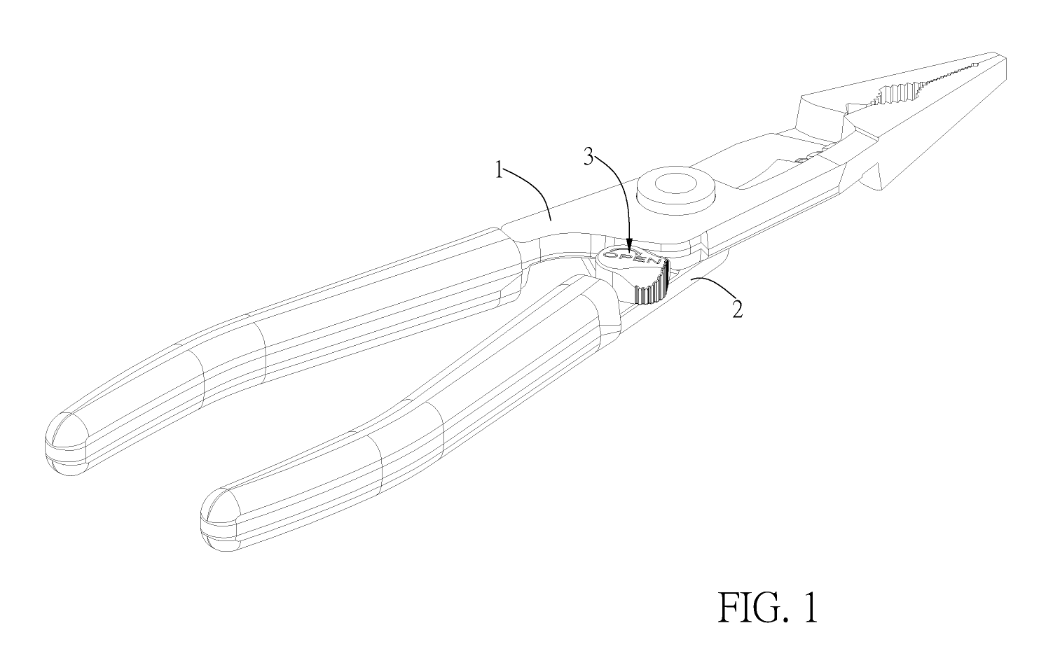

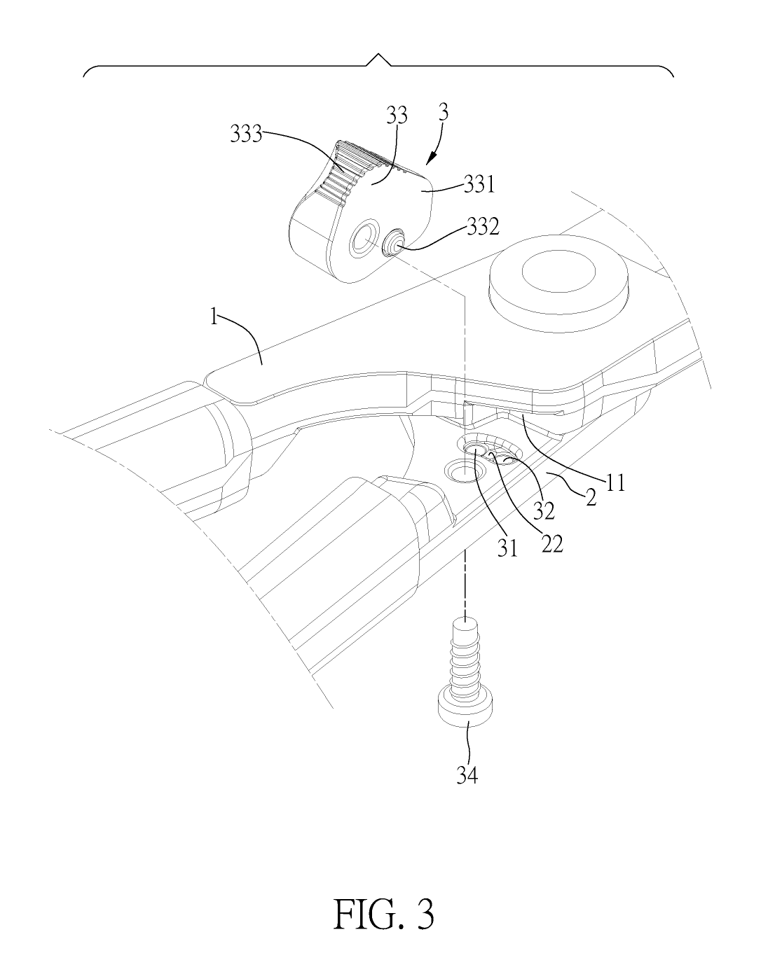

Please refer to FIGS. 1 to 3, illustrating a pliers according to a first embodiment of the present invention. In this embodiment, the pliers comprise a first pliers body 1, a second pliers body 2, and a tap-button mechanism 3. The first pliers body 1 is pivoted with the second pliers body 2, and a spring is received in a pivoting portion between the first pliers body 1 and the second pliers body 2, so that the first pliers body 1 is away from the second pliers body 2 in a normal state. The first pliers body 1 is pivotable relative to the second pliers body 2 to come close to or goes away from the second pliers body 2 for performing a cutting function. The first pliers body 1 comprises an engaging groove 11, and the engaging groove 11 is on one side of the first pliers body 1 and near the pivoting portion.

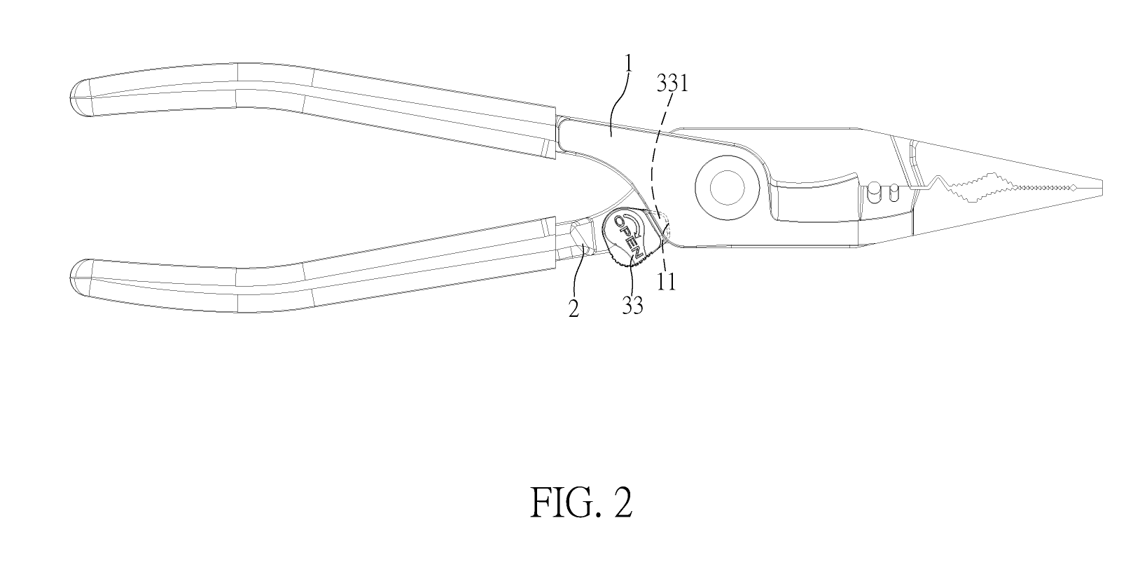

Moreover, the tap-button mechanism 3 is assembled on the second pliers body 2 and near the pivoting portion. The tap-button mechanism 3 comprises two positioning grooves 31, 32 and a tap button 33. In this embodiment, the tap button 33 has a blocking portion 331. The tap button 33 is pivoted on the second pliers body 2 and near the pivoting portion by a shaft 34, and the tap button 33 is capable of being tapped to a first position and a second position. When the first pliers body 1 and the second pliers 2 are closed with each other, the tap button 33 can be tapped to the first position, so that the blocking portion 331 is engaged in the engaging groove 11 of the first pliers body 1. Therefore, the first pliers body 1 is blocked by the tap button 3 and cannot pivoted relative to the second pliers body 2, and the pliers cannot be opened. In this embodiment, as shown in FIG. 2, the outline of the tap button 33 is round and smooth. Hence, when the blocking portion 331 is engaged in the engaging groove 11, the tap button 33 is closely and seamlessly attached on the first pliers body 1. Therefore, the tap button 33 would not engage with unwanted tool pieces to affect the operation of the pliers. Conversely, when the tap button 33 is tapped to the second position, the blocking portion 331 of the tap button 33 is detached from the engaging groove 11. Therefore, the first pliers body 1 is pivotable relative to the second pliers body 2, and the pliers can be opened.

In one embodiment, the tap button 33 may have an anti-skid pattern 333 for stable operation.

A positioning block 332 made of soft material is extending from the tap button 3 toward the second pliers body 2, and the positioning block 332 can be engaged in any of the positioning grooves 31, 32 according to the position of the tap button 33 for positioning the tap button 33. In this embodiment, the second pliers body 2 comprises an elongated slot 21, and the outline of the elongated slot 21 is curved to correspond to a trace of the tap button 33. The two positioning grooves 31, 32 are in the elongated groove 21 and hereinafter respectively called a left positioning groove 31 and a right positioning groove 32. Furthermore, a protruding portion 22 is between the two positioning grooves 31, 32.

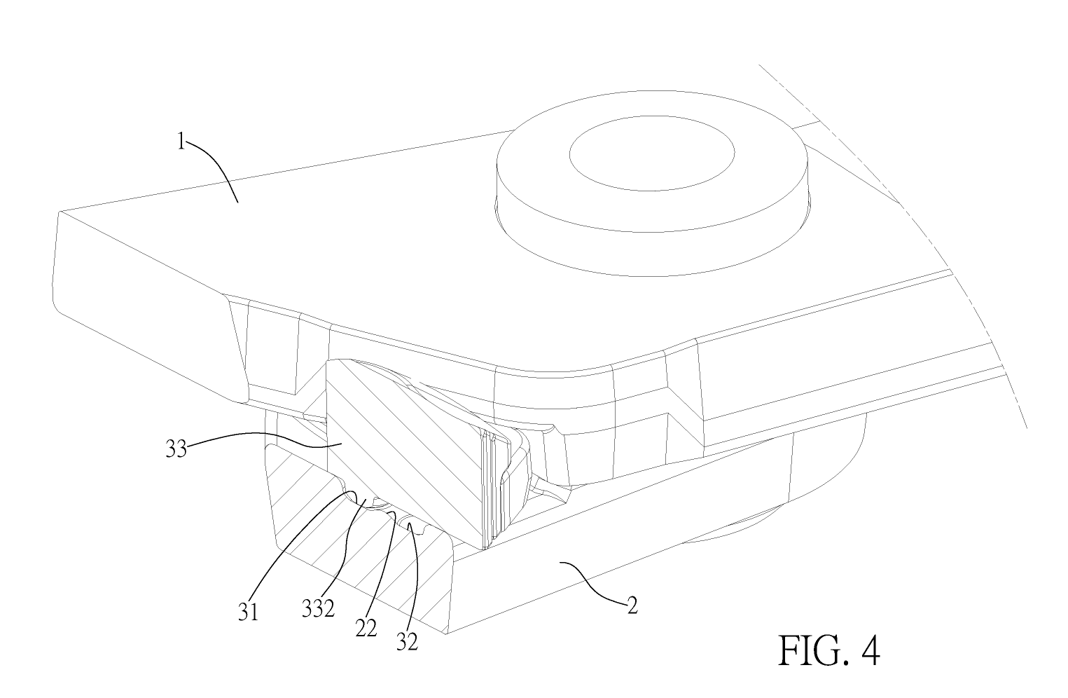

As above, as shown in FIG. 4, when the first pliers body 1 comes close to the second pliers body 2 and the tap button 33 is tapped to the first position for positioning the first pliers body 1, the positioning block 332 of the tap button 33 is engaged in the lest positioning groove 31, so that the tap button 33 is positioned by limitation of the left positioning groove 31 toward the positioning block 332. In other words, when a foreign force having a magnitude not greater than a certain value is applied to the tap button 33, the tap button 33 is not moved. Accordingly, the tap button 33 can be kept engaged into the engaging groove 11, so that the first pliers body 1 can be prevented from being pivoted relative to the second pliers body 2 and the pliers would not be opened unintentionally.

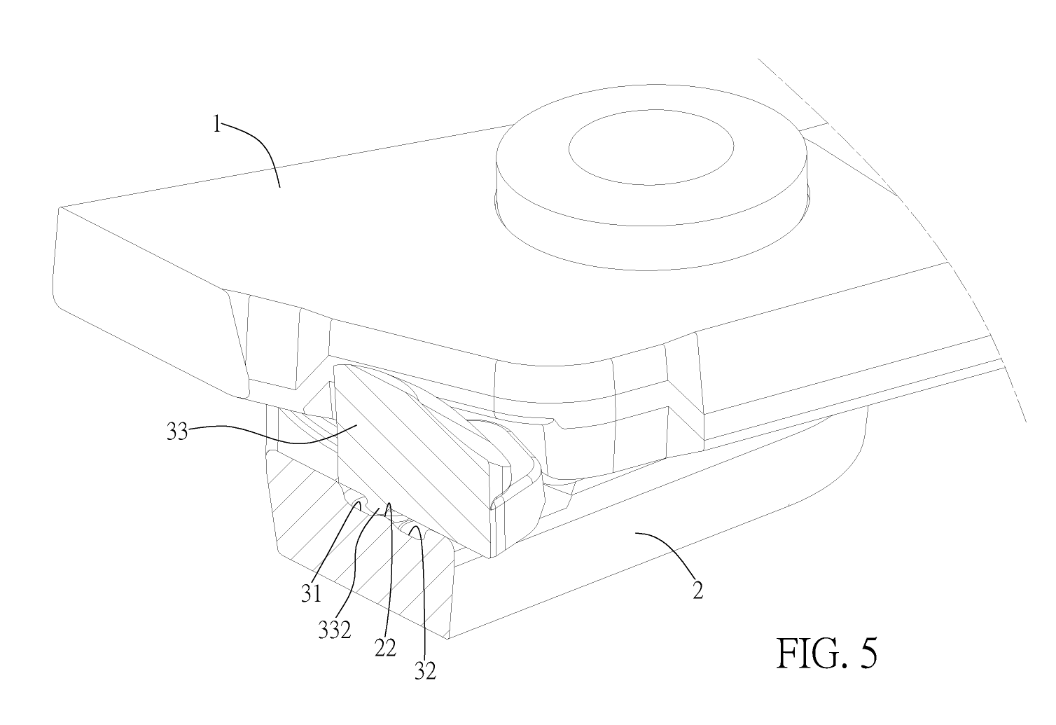

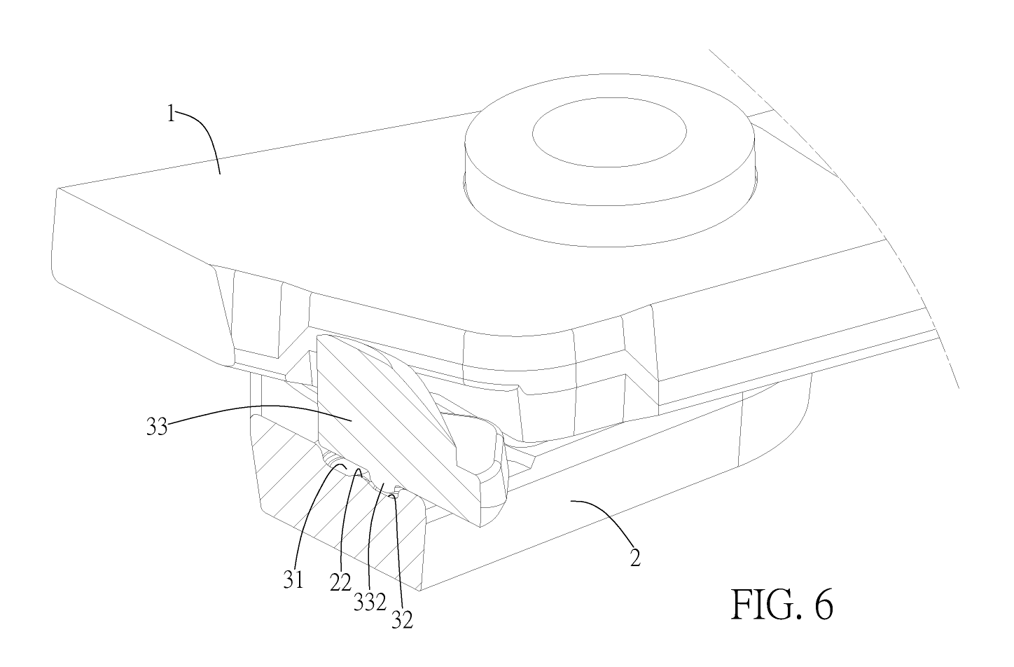

Conversely, when the pliers is to be used, the user can apply a force to the tap button 33 to tap the tap button 33 from the first position to the second position, then the tap button 33 is detached from the engaging groove 11 and the first pliers body 1 is freely pivotable relative to the second pliers body 2. As shown in FIG. 5, during the movement of the tap button 33, firstly, the positioning block 332 is detached from the left positioning groove 331. And then, because the positioning block 332 is made of the soft material and can be deformed when being compressed, the positioning block 332 goes across the protruding portion 22, moves to the right positioning groove 32, and engaged in the right engaging groove 32, as shown in FIG. 6. Accordingly, the tap button 33 can be positioned at the second position. Furthermore, as mentioned above, the tap button 33 is not moved by a force having a magnitude not greater than a certain value. Therefore, the tap button 33 can be prevented from being tapped in the engaging groove 11 unintentionally to affect the operation of the pliers.

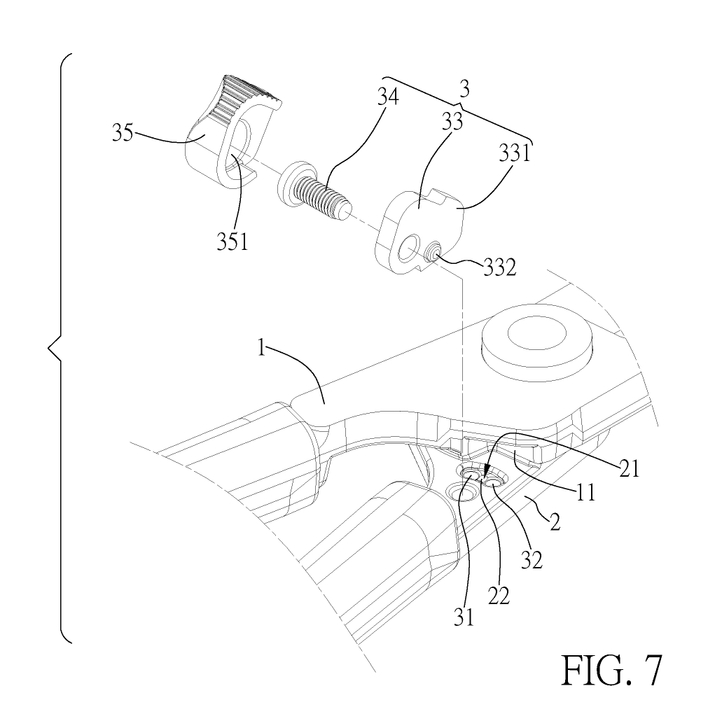

Furthermore, FIG. 7 illustrates a pliers according to a second embodiment of the present invention. In this embodiment, the tap-button mechanism 3 further comprises a housing 35 covering the tap button 33, and the housing 35 comprises a receiving groove 351 corresponding to the shaft 34 for receiving the shaft 34. Therefore, the shaft 34 is limited and protected in the housing 35. When the pliers is impacted, the shaft 34 would not be detached from the pliers easily to prevent the function failure of the tap-button mechanism 3.

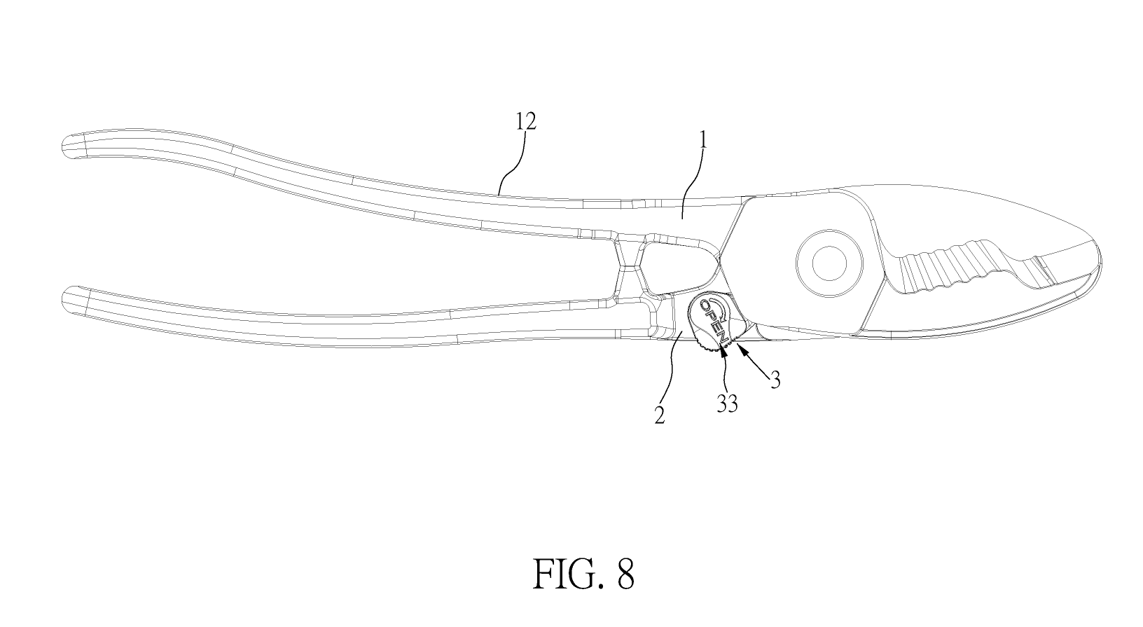

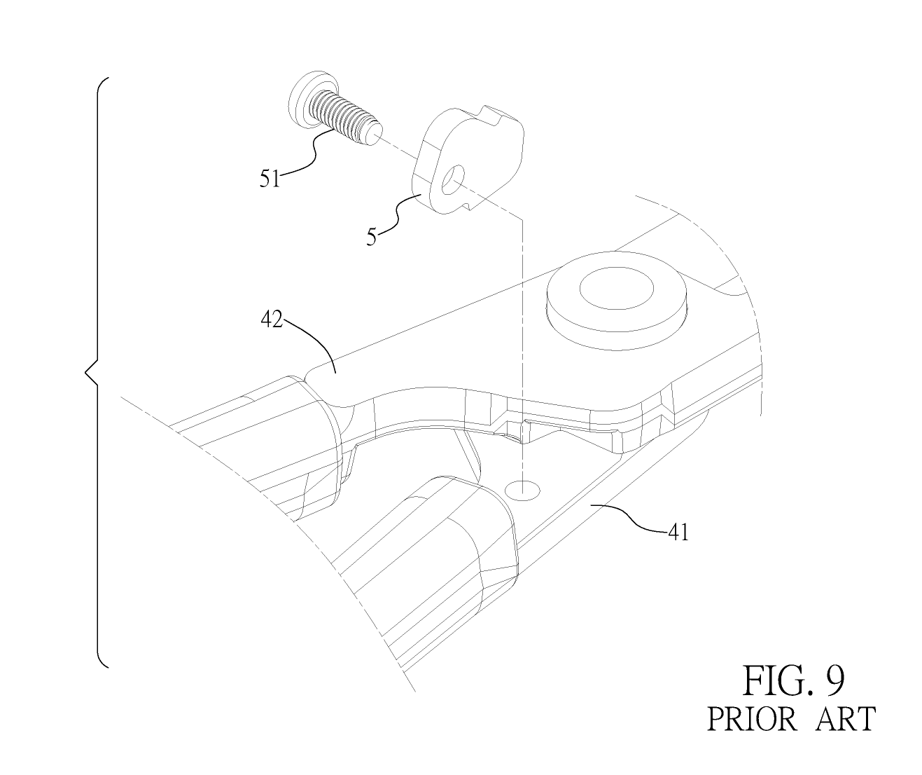

FIG. 8 illustrates a pliers according to a third embodiment of the present invention. In this embodiment, the first pliers body 1 has a surface 12 being arced and inwardly recessed. The user can use four fingers to hold the surface 12 and tap the tap button 33 with the thumb, so that the user can operate the tap-button mechanism 3 by one hand.

What is claimed is:

1. A pliers, comprising:
a first pliers body comprising an engaging groove;
a second pliers body pivoted with the first pliers body, so that the first pliers body is pivotable relative to the second pliers body to come close to the second pliers body or goes away from the second pliers body;
a tap-button mechanism comprising two positioning grooves at the second pliers body and a tap button pivoted on the second pliers body, wherein when the first pliers body comes close to the second pliers body, the tap button is capable of being tapped to a first position and engaged in the engaging groove, so that the first pliers body is blocked by the tap button in the engaging groove and cannot pivot relative to the second pliers body; the tap button is capable of being tapped to a second position and detached from the engaging groove, so that the first pliers body is pivotable relative to the second pliers body, a positioning block is extending from the tap button, and the positioning block can be engaged in any of the positioning grooves according to a position of the tap button for positioning the tap button.

2. The pliers according to claim 1, wherein the second pliers body comprises an elongated slot, and the two positioning grooves are in the elongated slot, and a protruding portion is protruding from the elongated slot and between the two positioning grooves.

3. The pliers according to claim 2, wherein an outline of the elongated slot is curved to correspond to a trace of the tap button.

4. The pliers according to claim 1, wherein the tap-button mechanism further comprises a housing covering the tap button.

5. The pliers according to claim 4, wherein the tap button is pivoted on the second pliers body by a shaft, and the housing comprises a receiving groove corresponding to the shaft.
